(19) United States
(12) Patent Application Publication
(10) Pub. No.: US 2021/0150629 A1
(43) Pub. Date: May 20, 2021

(54) Systems and Methods of Permanent Life Insurance Policy Side-by-side Comparison and Automated Underwriting

(71) Applicant: ILIFE TECHNOLOGIES, INC., Irvine, CA (US)

(72) Inventor: Ta Lee, Diamond Bar, CA (US)

(21) Appl. No.: 17/159,162

(22) Filed: Jan. 27, 2021

Related U.S. Application Data
(63) Continuation of application No. 16/864,041, filed on Apr. 30, 2020.
(60) Provisional application No. 62/878,226, filed on Jul. 24, 2019.

(51) Int. Cl. G06Q 40/08; G06Q 40/06

(52) U.S. Cl. CPC G06Q 40/08; G06Q 40/06

(57) ABSTRACT

Systems, devices, and methods including receiving, by a database controller that configures the processor, a user data from at least one remote server; normalizing, by a normalizer, the user data into a uniform standard format; generating, by the database controller, a comparison of: two or more permanent life insurance policies; receiving, by an application controller that configures the processor, an application for one or more of the generated two or more permanent life insurance policies; determining, by the application controller, a status of the application based on an automated underwriting; and transmitting, by the application controller, the determined status of the application to a user device for a user.

### CROSS-REFERENCE TO RELATED APPLICATIONS

This application is a continuation of U.S. application Ser. No. 16/864,041, filed Apr. 30, 2020, which application claims priority to and the benefit of U.S. Provisional Patent Application No. 62/878,226, filed Jul. 24, 2019, the contents of which are hereby incorporated by reference herein for all purposes.

### TECHNICAL FIELD

Embodiments relate generally to insurance policy comparison, and more particularly to systems and methods for providing users with side-by-side comparisons of permanent life insurance policy performances.

### BACKGROUND

Comparisons of term life insurance policy performances for a user may only consider the price for an end user. By contrast, permanent life insurance generally requires many metrics beyond just price. Due to the complexities inherent to permanent life insurance, cumbersome paperwork for multiple carriers is often required. Furthermore, underwriting procedures after filing of the paperwork can take extended periods of time, e.g. 30-60 days, and require a medical exam to draw blood and urine, submit additional personal medical and financial documents, as well as phone interviews.

### SUMMARY

A computer implemented method embodiment may include executing on a processor with addressable memory the steps of:

receiving, by a database controller that configures the processor, a user data from at least one remote server; normalizing, by a normalizer, the user data into a uniform standard format; generating, by the database controller, a comparison of: two or more permanent life insurance policies based on the normalized user data and one or more non-insurance investments based on the normalized user data; receiving, by an application controller that configures the processor, an application for one or more of the generated two or more permanent life insurance policies; determining, by the application controller, a status of the application based on an automated underwriting, where the automated underwriting may be based on at least one of: the normalized user data, a submitted user medical information, a submitted user financial information, and a submitted user survey questionnaire; and transmitting, by the application controller, the determined status of the application to a user device for a user.

In additional computer implemented method embodiments, the received user data comprises two or more separate user records having two or more file formats. In additional computer implemented method embodiments, normalizing the user data further comprises: parsing each user record to benchmark one or more user profile metrics common across the two or more file formats. In additional computer implemented method embodiments, the one or more user profile metrics may comprise at least one of: age, gender, smoker status, and different premium amounts, such as annual, monthly, and quarterly premium amounts. In additional computer implemented method embodiments, the uniform standard format may be an identical format for each parsed user record.

In additional computer implemented method embodiments, generating the comparison may further comprise: receiving a user preference for one or more user profile metrics; and sorting the normalized user data based on the received user preference. In additional computer implemented method embodiments, generating the comparison may further comprise: selecting the two or more permanent life insurance policies for comparison based on a closest match of the sorted user data to the received user preference for the one or more user profile metrics.

In additional computer implemented method embodiments, generating the comparison may further comprise: generating one or more projections for the two or more permanent life insurance policies. In additional computer implemented method embodiments, generating the comparison further comprises: comparing the generated one or more projections to one or more non-insurance investments. In additional computer implemented method embodiments, the one or more non-insurance investments includes one or more of: a savings account, S&P 500 Index, and bonds.

In additional computer implemented method embodiments, receiving the application further comprises: populating one or more answers of the application into two or more forms associated with two or more life insurance carriers associated with the two or more permanent life insurance policies; submitting each form of the two or more forms to each life insurance carrier of the two or more life insurance carriers, where the submitted form does not require medical paperwork.

A system embodiment for side-by-side comparison of permanent life insurance policies may include: at least one remote server storing data from at least two permanent life insurance carriers; and a user computing device comprising: a processor having addressable memory; and a user interface; where the at least one remote server may be configured to: receive, by a database controller, user data and load the user data into a database program; normalize, with a normalizer, the received user data into a uniform standard format; perform, by a side-by-side comparator, advanced analytics on the normalized data to provide a side-by-side comparison of at least two permanent life insurance policies of the at least two permanent life insurance carriers based on a user profile; apply, with an application controller, to at least one permanent life insurance policy of the two or more permanent life insurance policies of the provided side-by-side comparison; and execute an automated underwriting to provide an approval or disapproval status to the user; where the user computing device may be configured to: send, with the user interface, the user profile to the at least one remote server; display, with the user interface, the side-by-side comparison of the at least two permanent life insurance policies and at least one non-insurance investment; and send, with the user interface, an application for at least one of the at least two permanent life insurance policies.

In additional system embodiments, the user data received by the remote server comprises two or more separate user records having two or more file formats. In additional system embodiments, as part of normalizing the received user data into the uniform standard format the at least one remote server may be further configured to: parse each user record to benchmark one or more user profile metrics common across the two or more file formats. In additional system embodiments, the one or more user profile metrics may comprise at least one of: age, gender, smoker status, and different premium amounts, such as annual, monthly, and quarterly premium amounts, and where the uniform standard format may be an identical format for each parsed user record.

In additional system embodiments, as part of performing advanced analytics on the normalized data the at least one remote server may be further configured to: receive a user preference for one or more user profile metrics; sort the normalized user data based on the received user preference; and select the two or more permanent life insurance policies for comparison based on a closest match of the sorted user data to the received user preference for the one or more user profile metrics.

In additional system embodiments, as part of performing advanced analytics on the normalized data the at least one remote server may be further configured to: generate one or more projections for the two or more permanent life insurance policies. In additional system embodiments, as part of performing advanced analytics on the normalized data the at least one remote server may be further configured to: compare the generated one or more projections to one or more non-insurance investments. In additional system embodiments, the one or more non-insurance investments includes one or more of: a savings account, S&P 500 Index, and bonds.

In additional system embodiments, as part of applying to the least one permanent life insurance policy the at least one remote server may be further configured to: populate one or more answers of the application into two or more forms associated with two or more life insurance carriers associated with the two or more permanent life insurance policies; and submit each form of the two or more forms to each life insurance carrier of the two or more life insurance carriers, where the submitted form does not require medical paperwork.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a top-level functional block diagram of a computing system environment;

FIG. 2 depicts components in communication with a processor of the computing system of FIG. 1;

FIG. 3 depicts a side-by-side comparison of permanent insurance policies within the computing system of FIG. 1;

FIG. 4 depicts various metrics related to the side-by-side comparison of FIG. 3;

FIG. 5 depicts advanced analytics related to the side-by-side comparison of FIG. 3;

FIG. 6 depicts a flow diagram for providing a user with side-by-side comparisons of permanent life insurance policy performances;

FIG. 7 depicts a flow diagram of automated underwriting for permanent life insurance policy application approval;

FIG. 8 shows a high-level block diagram and process of a computing system for implementing an embodiment of the system and process;

FIG. 9 shows a block diagram and process of an exemplary system in which an embodiment may be implemented; and

FIG. 10 depicts a cloud computing environment for implementing an embodiment of the system and process disclosed herein.

### DETAILED DESCRIPTION

The described technology concerns one or more methods, systems, apparatuses, and mediums storing processor-executable process steps of providing a user or users with side-by-side comparisons of permanent life insurance policy performances, allow the user to apply for multiple different carriers' products simultaneously, and perform online, automated underwriting based on user-submitted data, such as financial and medical information. The techniques introduced below may be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

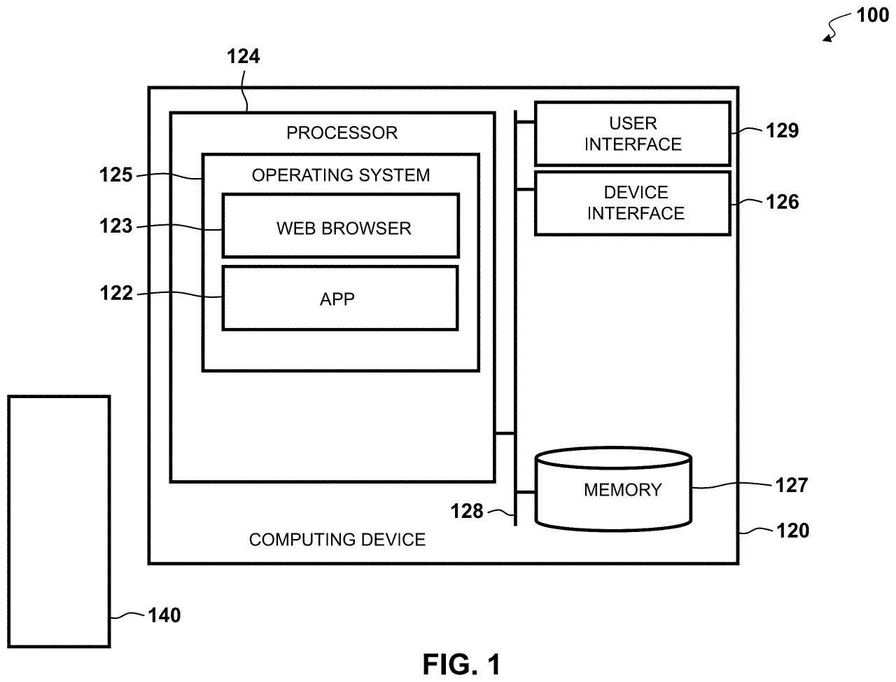

FIGS. 1-10 and the following discussion provide a brief, general description of a suitable computing environment in which aspects of the described technology may be implemented. Although not required, aspects of the technology may be described herein in the general context of computer-executable instructions, such as routines executed by a general- or special-purpose data processing device (e.g., a server or client computer). Aspects of the technology described herein may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer-implemented instructions, data structures, screen displays, and other data related to the technology may be distributed over the Internet or over other networks (including wireless networks) on a propagated signal on a propagation medium (e.g., an electromagnetic wave, a sound wave, etc.) over a period of time. In some implementations, the data may be provided on any analog or digital network (e.g., packet-switched, circuit-switched, or other scheme).

The described technology may also be practiced in distributed computing environments where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Those skilled in the relevant art will recognize that portions of the described technology may reside on a server computer, while corresponding portions may reside on a client computer (e.g., PC, mobile computer, tablet, or smart phone). Data structures and transmission of data particular to aspects of the technology are also encompassed within the scope of the described technology.

Present embodiments provide for automated online underwriting, eliminating the need to interview the user for verification of medical information, and the need to interact in person with an insurance agent or a reinsurance company.

In one embodiment of the system of the present disclosure, side-by-side comparisons of permanent life insurance policy performances and simultaneous application for multiple different carriers' products are performed. In one embodiment, many, e.g., millions, of permanent life insurance policies on the market may be gathered, analyzed, and compared directly side-by-side, using advanced analytics for direct comparisons between carriers to analyze cash values, the potential for growth, and risk associated with the cash value as an investment or savings alternative for each permanent life insurance policy. The system may utilize metrics such as risk-adjusted turns, tax-adjusted returns, liquidity comparisons, and true cost of insurance.

In one embodiment the system of the present disclosure, performance illustrations from different carriers are gathered simultaneously and analyzed to account for the methodological differences of each data source.

In one embodiment the system of the present disclosure, “Real Offers” may be compared side-by-side in real-time. The system also provides for automated underwriting-approved offers, for multiple carriers, in an automated manner, with data aggregation included. In one embodiment, the automated underwriting-approved offers are provided to the end user in approximately 30 minutes.

FIG. 1 illustrates an example of a top-level functional block diagram of a computing system embodiment 100. The example operating environment is shown with a server computer 140 and a computing device 120 comprising a processor 124, such as a central processing unit (CPU), addressable memory 127, an external device interface 126, e.g., an optional universal serial bus port and related processing, and/or an Ethernet port and related processing, and an optional user interface 129, e.g., an array of status lights and one or more toggle switches, and/or a display, and/or a keyboard and/or a pointer-mouse system and/or a touch screen. Optionally, the addressable memory may include any type of computer-readable media that can store data accessible by the computing device 120, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network, such as a LAN, WAN, or the Internet. These elements may be in communication with one another via a data bus 128. In some embodiments, via an operating system 125 such as one supporting a web browser 123 and applications 122, the processor 124 may be configured to execute steps of a process establishing a communication channel and processing according to the embodiments described above.

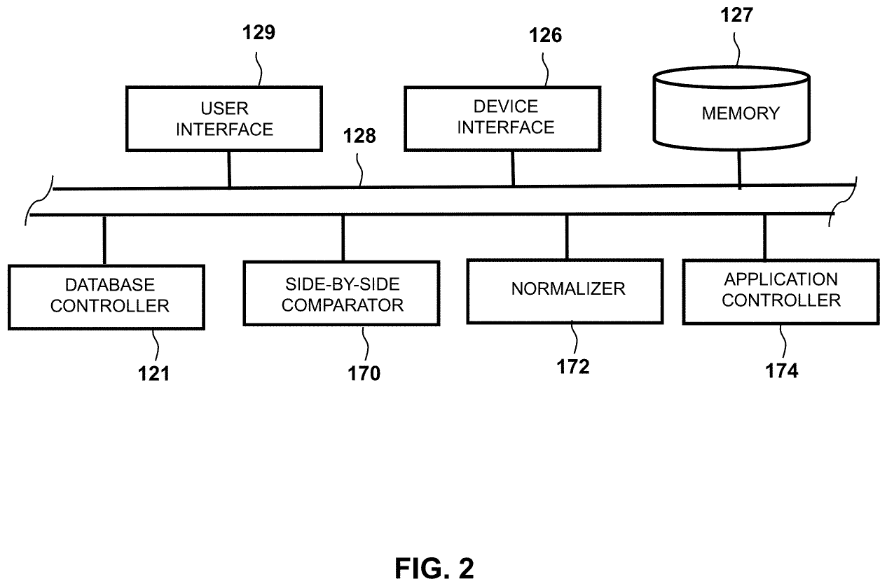

With respect to FIG. 2, components associated with or in communication with the processor 124 are shown. A database controller 121 may be in communication with the processor 124, for example, via the data bus 128. In one embodiment, the database controller 121 may receive user data from various insurance providers from at least one database, such as a database associated with the server computer 140 in FIG. 1, and load said data into a cross-platform document-oriented database program. In one embodiment, the data may be uploaded in bulk into the database as separate user records. A normalizer 172 may normalize the user data into a uniform format. More specifically, the normalizer 172 may take the imported user data from various insurance providers which may be in different file formats, and parse each user data file to benchmark various user profile metrics that are common across different file formats, such as age, gender, different premium amounts, such as annual, monthly, and quarterly premium amounts, and the like. The normalizer may bind the user data imported from each insurance provider into an identical format. In one embodiment, the normalizer 172 may organize fields and/or tables, such as fields and tables associated with user data from each insurance provider into a uniform standard format. In one embodiment, two main tables may be compiled in the database, a “preferences master” and an “illustrations master”. In one embodiment, and based on the user profile and a user's preferences, the normalizer 172 may sort the formatted data and match the user with insurance policies that align with the user's preferences. For example, if a user preference is a premium of $1,000, the normalizer 172 may sort the data based on quoted insurance premium values for the user and the normalizer 172 may select the two policies with the closest quoted premium value to the user's preferred premium value. A side-by-side comparator 170 may receive the normalized data from the normalizer (172) to perform advanced analytics on the data to provide a side-by-side comparison of permanent life insurance policies of the at least two permanent life insurance policy carriers based on a user profile. The user profile may contain information such as age, gender, smoker/non-smoker, and the like. In one embodiment, the side-by-side comparator 170 may use advanced analytics to perform and display (e.g., with the user interface 129) the side-by-side comparison in real time. In one embodiment, the side-by-side comparator 170 may display projections, such as future cash values, risk adjusted return, risk & volatility history, insurance savings, etc., versus non-insurance investments, such as savings accounts, the S&P 500, bonds, and the like. In one embodiment, the comparisons are displayed on the user interface 129.

An application controller 174 may allow a user to apply to one of the permanent life insurance policies presented to the user by the side-by-side comparator 170. In another embodiment, the user may apply with the application controller 174 to both of the permanent life insurance policies presented to the user by the side-by-side comparator 170 simultaneously.

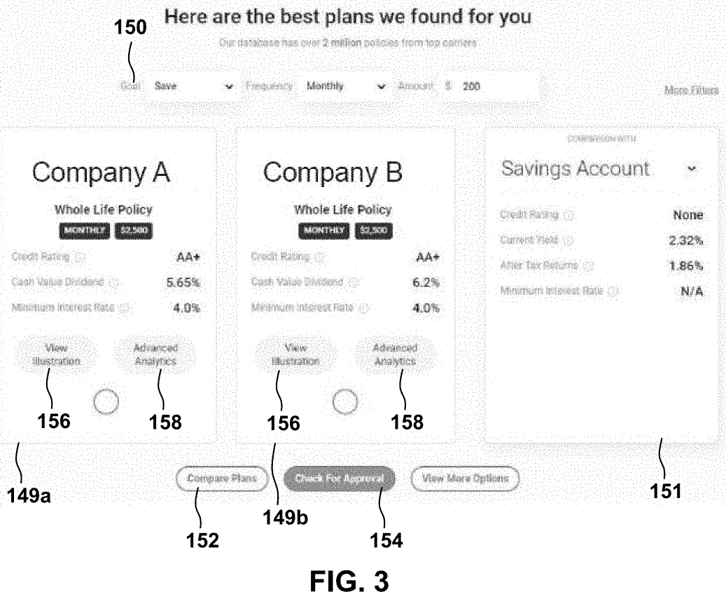

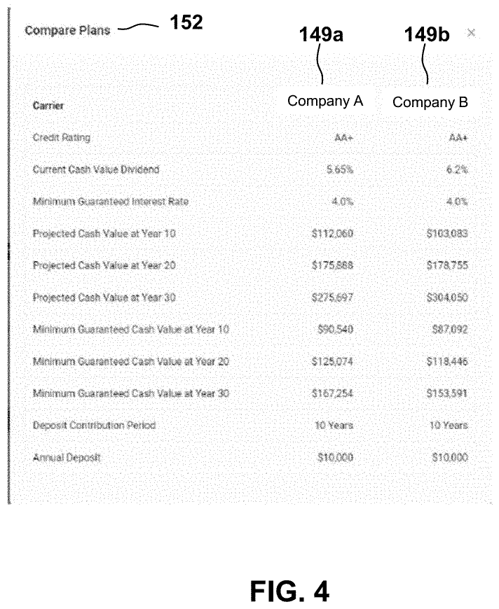

With respect to FIG. 3, the system 100 may provide for comparison of permanent life insurance policy performances side-by-side. In one embodiment, the side-by-side comparator 170 displays the comparisons in the same dashboard for quick visualization of performance comparisons between policies, as well as between permanent policies and non-insurance alternatives. More specifically, a user may interact with the user interface 129 to make side-by-side comparisons of permanent insurance policies, as well as with non-insurance investments, such as savings accounts, CDs, Bonds, the S&P 500, and the like. In one embodiment, a user may be presented with permanent insurance policy carriers 149a,b as well as a savings account option 151 for comparison. In one embodiment, a user may select a “goal” from a Goal drop-down menu 150, such as “save”, “invest”, or “insure”. Generally speaking, a permanent insurance policy may be considered an investment and/or savings asset. In one embodiment, the user may select to “save” via the Goal drop-down menu 150. The user may further select the frequency of which to save as well as the dollar amount to save. For example, the user may select for putting $200 every month towards a savings asset. In one embodiment, and with respect to FIG. 4, the user may view a side-by-side comparison of various metrics (beyond just price) related to the policies 149a,b, such as credit rating, current cash value dividend, projected cash values, minimum guaranteed cash values, deposit contribution period, and annual deposit. The user may view these metrics by selecting a Compare Plans button 152 of FIG. 3.

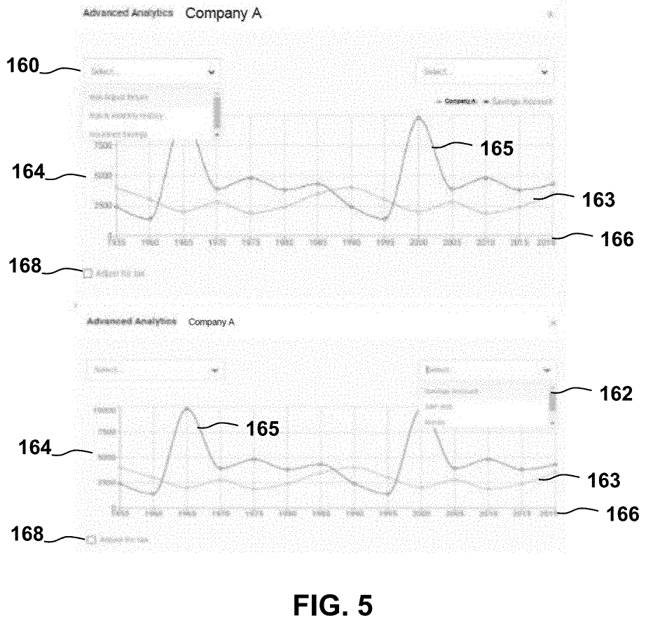

The user may also view, e.g., at the user interface 129, side-by-side advanced analytics comparisons between insurance policies, such as policies 149a,b and non-insurance investments, such as the savings account 151. More specifically, a user may select an Advanced Analytics button 158 of either policy 149a of policy 149b, as shown in FIG. 3. With respect to FIG. 5, the user has selected to view an advanced analytics side-by-side comparison of policy 149a with savings account 151. In another embodiment, the user may select a View Illustration button 156 to view a set of projections, typically prepared by the actuarial department of the particular insurance carrier.

The advance analytics comparison may be done in real time. Furthermore, all projections (e.g., risk adjusted return, risk & volatility history, insurance savings, etc.) may be viewed versus non-insurance investments, such as savings accounts, the S&P 500, bonds, and the like. For example, the user may select “risk adjust return” from a first drop-down menu 160, shown in the top panel of FIG. 5. The user then selects “Savings Account”, such as savings account 151 from a second drop-down menu 162, shown in the lower panel. A first curve 163 shows the risk adjusted return performance of the first policy carrier 149a over time, with the risk adjust return value on a y-axis 164 and the years over which the risk adjust return value has been measured on an x-axis 166. A second curve 165 shows the same risk adjust return performance over time, but for the savings account 151. In one embodiment, the data associated with risk adjust return data (as well as the data associated with other metrics for side-by-side comparison) may be received in different formats from different carriers, e.g., at the database controller 121. The data in different formats may be normalized to be in the same format. Additionally, the user may select an “adjust for tax” button or checkbox 168, which allows for a one-to-one comparison amongst carriers and non-insurance investment options.

In one embodiment, the insurance data may be manually queried from the insurance carriers and stored in a database, such as server 140 in FIG. 1. In another embodiment, the system 100 may automatically retrieve updated data as it is released from the insurance carriers, such as with a deep learning algorithm.

The user may check for approval with a Check For Approval button 154 in FIG. 3, and an approval status may be displayed to the user. In one embodiment, the user may be required to provide further details if the user is not approved. The user may continuously add additional information to see if the user is provided approval.

In one embodiment, the user may apply for more than one policy at the same time. In one embodiment, the system 100 may provide for algorithmic underwriting after a user decides to be insured by one policy or more than one policy. Algorithmic underwriting of the data means then there is no need to interview the client for verification of medical information. In one embodiment, the algorithmic underwriting may be done online via the system 100 without the need for the user to interact in person with an insurance agent or a reinsurance company. In one embodiment, a user may submit, e.g., with the application controller 174 of FIG. 2, medical information, financial information, and/or a survey questionnaire to one or more insurance companies. The financial information may be received by a third party application programming interface (API). The third party API may be associated with a financial institution, such as a bank. The medical information may be received by a third party API, and the third party API may be associated with a medical institution, such as a hospital, clinic, or the like. The financial and medical data are queried from the third parties. In the event that the third parties will not release the financial and/or medical information, then the survey questionnaire may be uploaded to the server 140 and retrieved by the database controller 121. The data are compiled in a standard format (e.g., file format that may be recognized on an operating system, such as operating system 125 of FIG. 1) to be used in the automated underwriting process. More specifically, the processor 124 of FIG. 1 may execute steps to perform automated underwriting to provide an approval decision based on the user's submitted data. The user may then be presented with an approval or disapproval status at the user interface 129 of FIGS. 1-2.

Certain medical data may vary over time, and the system 100 may identify these sets of variables, such as smoking. For example, a user may indicate that they do not smoke, but a user's last medical appointment from the past indicates that they were a smoker in the past. The system 100 allows for the user to explain their current situation, e.g., how long they have quit smoking for. An insurance carrier may then query the user via a chat platform of the system 100 to fill out additional information or documentation for the medical variables in question. This provides an opportunity for the user to interact with the algorithmic underwriting system. The user may also interact with insurance agents and reinsurance companies via the chat platform as well.

As the user interacts with agents, reinsurance companies, and permanent life insurance carriers a myriad of behavioral data may be received, for example, at the database controller 121. The system 100 may become more efficient at providing side-by-side comparisons to the user based on the user's profile and history of interactions with agents, reinsurance companies, and permanent life insurance carriers.

In one embodiment, a user may retrieve the contracts of any insurance carrier in real time so the user may do their due diligence on their own terms. This eliminates the possibility of an agent baiting and switching with users as they talk in person, because the agent is unable to change the policy on the spot as the user may change their mind, e.g., the user divulges in person to the agent that they are actually a smoker.

The system 100 provides for application for multiple different carriers' products simultaneously without filling redundant sets of paperwork. In one embodiment, a user may receive offers in a short amount of time, e.g., within twenty minutes, without a medical exam. The system 100 may provide for aggregating and standardizing the format of all relevant medical records and financial information of the user.

In one embodiment, the processor 124 may be in communication with the database controller 121 to execute steps to collect many, e.g., millions, of sets of insurance policy data from insurance carriers stored on at least one server, such as the server 140. The normalizer 172 may then bind the data imported from each insurance provider into an identical format. The processer 124 may then be in communication with the side-by-side comparator 170 to execute step to compare the true performances side-by-side using objective metrics to analyze cash values, the potential for growth, and risk associated with the cash value as an investment or savings alternative for each permanent life insurance policy. Such metrics may include risk-adjusted turns, tax-adjusted returns, liquidity comparisons, and true cost of insurance.

In one embodiment, the processor 124 of FIG. 1 may execute the application 122 of FIG. 1 to prompt the user with key questions to auto-populate the user's answers into different forms associated with different carriers to avoid redundant paperwork. The application 122 of FIG. 1 may provide for integration of an e-signature on the spot to avoid need for any physical paperwork.

The processor 124 of FIG. 1 may then execute steps to submit the forms to reinsurance carriers, whose reinsurance engine may integrated into the application 122 of FIG. 1 of the computing device 120 of FIG. 1 to provide underwriting decisions without requiring medical paperwork or further documents. In one embodiment, the reinsurance result is provided to front-facing carriers. The carriers may then decide to co-insure the user, and issue an offer in that carrier's name (also without medical paperwork).

In one embodiment, the user may enter their payment information into the application 122 of FIG. 1. The processor 124 may then execute steps to complete the transaction with the policy getting placed and becoming effective immediately; therefore, it is not required to send a check or wire money.

In one embodiment, the user's application may be auto-populated. More specifically, the system provides for auto filling the user application information based on scanning the user's driver's license and/or any form of identification which requires a specific format, such as PDF417 format. In one embodiment, a portion of the application may be auto-filled based on data received from a third party.

In one embodiment, the system provides a direct-to-consumer web application online, without requiring the presence of a human. The system may include an interactive tool to help agents/advisors engage more efficiently in a more enjoyable experience, without the presence of a human being.

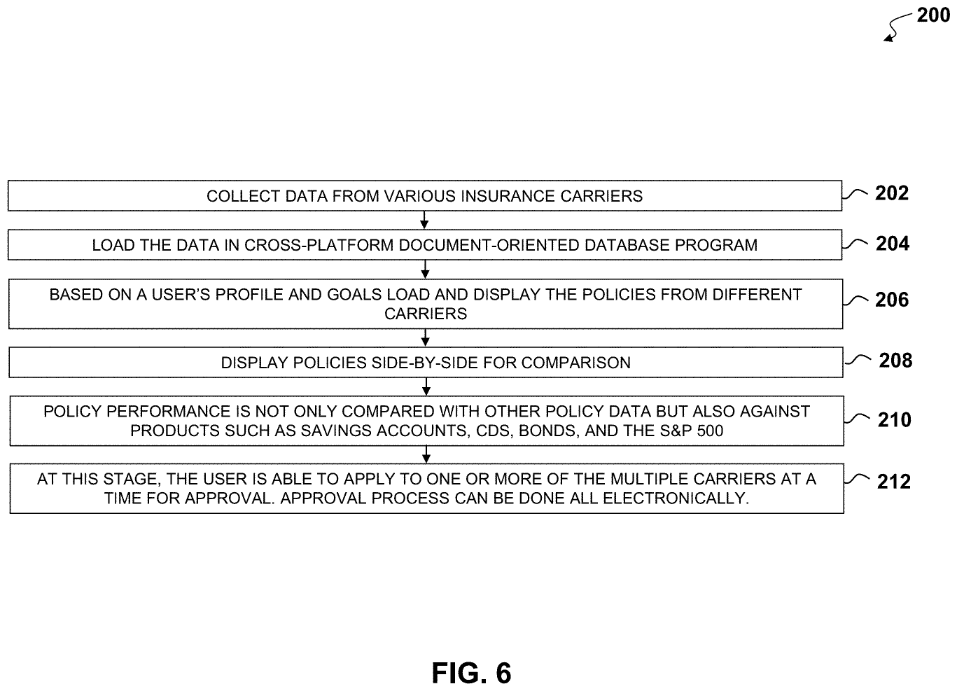

With respect to FIG. 6, a flow diagram 200 for providing a user, or multiple users, with side-by-side comparisons of permanent life insurance policy performances is illustrated. At step 202, data may be received, such as at the database controller 121 of FIG. 2, from a remote server, such as remote server 140 of FIG. 1. At step 204, the data may be loaded with the database controller 121 of FIG. 2 into a database program, such as a cross-platform document-oriented database program. The data structure may be in a different format from the different insurance carriers, and the cross-platform document-oriented database program may restructure the different formats into a single, coherent format. At step 206, the system 100 may load and display multiple insurance policies to a user based on the user's profile. The user profile may contain information such as age, gender, smoker/non-smoker, and the like. In one embodiment, a coverage amount, a health rating, and a premium amount, such as annual, monthly, and quarterly premium amount (and type of illustration, such as term or whole life insurance) may be displayed for each selected insurance carrier side-by-side to the user. At step 208, the policies selected by the system 100 based on the user's profile may be displayed for the user to visualize a side-by-side comparison. In one embodiment, the side-by-side comparison is generated with the side-by-side comparator 170, which may perform advanced analytics on the data to provide a side-by-side comparison of permanent life insurance policies in real time. At step 210, the side-by-side comparator 170 also provides for comparisons between selected insurance policies based on the user's profile as well non-insurance investments, such as savings accounts, the S&P 500, bonds, and the like. At step 212, the user may then apply, e.g., with the application controller 174, to one or all of the permanent life insurance policies presented to the user by the side-by-side comparator 170 simultaneously.

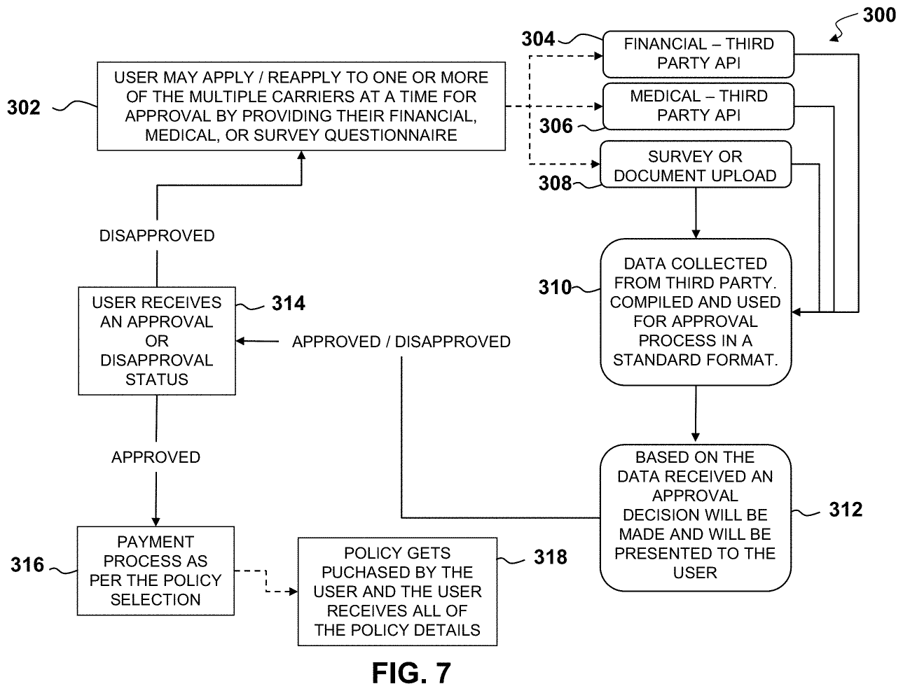

With respect to FIG. 7, a flow diagram 300 for automated underwriting for permanent life insurance policy application approval is illustrated. At step 302, a user may apply or reapply to one of the insurance policies, such as the insurance policies provided by the side-by-side comparator 170 at step 210 of FIG. 6. In another embodiment, the user may apply or reapply to each of the insurance policies provided by the side-by-side comparator 170 of FIG. 2 at the same time. In one embodiment, the system provides a secure registration and login to the user. The user may submit medical information, financial information, and/or a survey questionnaire to one or more insurance companies. At step 304, the financial information may be received by a third party application programming interface (API). The third party API may be associated with a financial institution, such as a bank. At step 306, the medical information may be received by a third party API, and the third party API may be associated with a medical institution, such as a hospital, clinic, or the like. In the event that the third parties will not release the financial and/or medical information, then the survey questionnaire may be uploaded a server, such as the server 140 of FIG. 1 and retrieved, such as by the database controller 121 of FIG. 2.

At step 310, the financial and medical data are queried from the third parties and the survey questionnaire (if provided) may be retrieved from the server. The data may be compiled in a standard format, e.g., file format that may be normalized, such as with normalizer 172. In one embodiment, the normalizer 172 may organize fields and/or tables, such as fields and tables associated with user profile data from various insurance providers received at a relational database, e.g., database controller 121, into a uniform standard format. More specifically, and at step 312, the processor 124 of FIG. 1 may execute steps to perform automated underwriting to provide an approval decision based on the user's submitted data. In one embodiment, automated underwriting may be done online via the system without the need for the user to interact in person with an insurance agent or a reinsurance company. Generally speaking, permanent life insurance underwriting is a multi-step process requiring a user to apply to each insurance company individually based on communication with an insurance company-appointed agent, have their application processed by the insurance company, then an insurance carrier representative may contact the user for a medical exam, where a medical examiner may come to the user for to conduct a medical exam. Therefore, multiple parties are involved in the process, which may take 30-60 days. At step 312, automatic underwriting based on the user's submitted data (e.g., medical records, financial records, etc.) may be executed without the need for an agent or broker to interview the client for verification of medical information. In one embodiment, the algorithmic underwriting may be done online, e.g., via the system 100, without the need for the user to interact in person with an insurance agent or a reinsurance company. Furthermore, the algorithmic underwriting may be executed after a user decides to be insured by one policy or more than one policy. In one embodiment, the automatic underwriting process may take approximately 30 minutes. At step 314, the user may then be presented with an approval or disapproval status at the user interface 129 of FIGS. 1-2. If the user has not been approved, then the user may return to step 302 to reapply to one or multiple carriers. In one embodiment, the user may provide additional medical and financial information to the third party APIs. At step 316, a payment process is begun if the user has been approved. The amount of payment is based on the policy or policies selected by the user. At step 318, the user purchases the policy and receives all of the policy details in real time.

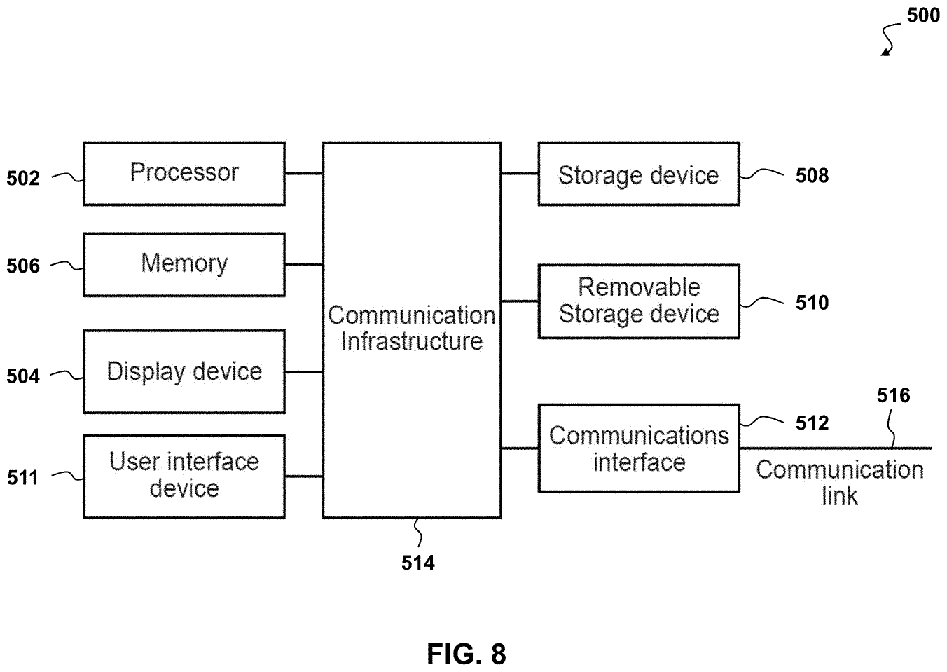

FIG. 8 is a high-level block diagram 500 showing a computing system comprising a computer system useful for implementing an embodiment of the system and process, disclosed herein. Embodiments of the system may be implemented in different computing environments. The computer system includes one or more processors 502, and can further include an electronic display device 504 (e.g., for displaying graphics, text, and other data), a main memory 506 (e.g., random access memory (RAM)), storage device 508, a removable storage device 510 (e.g., removable storage drive, a removable memory module, a magnetic tape drive, an optical disk drive, a computer readable medium having stored therein computer software and/or data), user interface device 511 (e.g., keyboard, touch screen, keypad, pointing device), and a communication interface 512 (e.g., modem, a network interface (such as an Ethernet card), a communications port, or a PCMCIA slot and card). The communication interface 512 allows software and data to be transferred between the computer system and external devices. The system further includes a communications infrastructure 514 (e.g., a communications bus, cross-over bar, or network) to which the aforementioned devices/modules are connected as shown.

Information transferred via communications interface 514 may be in the form of signals such as electronic, electromagnetic, optical, or other signals capable of being received by communications interface 514, via a communication link 516 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 512. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

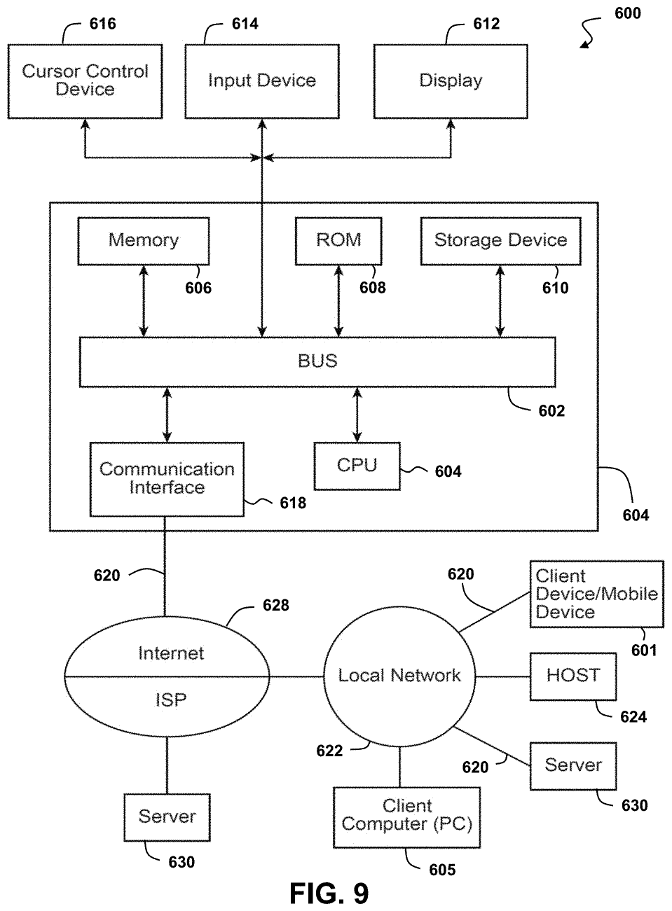

FIG. 9 shows a block diagram of an example system 600 in which an embodiment may be implemented. The system 600 includes one or more client devices 601 such as consumer electronics devices, connected to one or more server computing systems 630. A server 630 includes a bus 602 or other communication mechanism for communicating information, and a processor (CPU) 604 coupled with the bus 602 for processing information. The server 630 also includes a main memory 606, such as a random access memory (RAM) or other dynamic storage device, coupled to the bus 602 for storing information and instructions to be executed by the processor 604. The main memory 606 also may be used for storing temporary variables or other intermediate information during execution or instructions to be executed by the processor 604. The server computer system 630 further includes a read only memory (ROM) 608 or other static storage device coupled to the bus 602 for storing static information and instructions for the processor 604. A storage device 610, such as a magnetic disk or optical disk, is provided and coupled to the bus 602 for storing information and instructions. The bus 602 may contain, for example, thirty-two address lines for addressing video memory or main memory 606. The bus 602 can also include, for example, a 32-bit data bus for transferring data between and among the components, such as the CPU 604, the main memory 606, video memory and the storage 610. Alternatively, multiplex data/address lines may be used instead of separate data and address lines.

The server 630 may be coupled via the bus 602 to a display 612 for displaying information to a computer user. An input device 614, including alphanumeric and other keys, is coupled to the bus 602 for communicating information and command selections to the processor 604. Another type or user input device comprises cursor control 616, such as a mouse, a trackball, or cursor direction keys for communicating direction information and command selections to the processor 604 and for controlling cursor movement on the display 612.

According to one embodiment, the functions are performed by the processor 604 executing one or more sequences of one or more instructions contained in the main memory 606. Such instructions may be read into the main memory 606 from another computer-readable medium, such as the storage device 610. Execution of the sequences of instructions contained in the main memory 606 causes the processor 604 to perform the process steps described herein. One or more processors in a multi-processing arrangement may also be employed to execute the sequences of instructions contained in the main memory 606. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 604 for execution. Such a medium may take many forms, including but not limited to, non-volatile media, volatile media, and transmission media. Non-volatile media includes, for example, optical or magnetic disks, such as the storage device 610. Volatile media includes dynamic memory, such as the main memory 606. Transmission media includes coaxial cables, copper wire and fiber optics, including the wires that comprise the bus 602. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 604 for execution. For example, the instructions may initially be carried on a magnetic disk of a remote computer. The remote computer can load the instructions into its dynamic memory and send the instructions over a telephone line using a modem. A modem local to the server 630 can receive the data on the telephone line and use an infrared transmitter to convert the data to an infrared signal. An infrared detector coupled to the bus 602 can receive the data carried in the infrared signal and place the data on the bus 602. The bus 602 carries the data to the main memory 606, from which the processor 604 retrieves and executes the instructions. The instructions received from the main memory 606 may optionally be stored on the storage device 610 either before or after execution by the processor 604.

The server 630 also includes a communication interface 618 coupled to the bus 602. The communication interface 618 provides a two-way data communication coupling to a network link 620 that is connected to the world wide packet data communication network now commonly referred to as the Internet 628. The Internet 628 uses electrical, electromagnetic or optical signals that carry digital data streams. The signals through the various networks and the signals on the network link 620 and through the communication interface 618, which carry the digital data to and from the server 630, are exemplary forms or carrier waves transporting the information.

In another embodiment of the server 630, interface 618 is connected to a network 622 via a communication link 620. For example, the communication interface 618 may be an integrated services digital network (ISDN) card or a modem to provide a data communication connection to a corresponding type of telephone line, which can comprise part of the network link 620. As another example, the communication interface 618 may be a local area network (LAN) card to provide a data communication connection to a compatible LAN. Wireless links may also be implemented. In any such implementation, the communication interface 618 sends and receives electrical electromagnetic or optical signals that carry digital data streams representing various types of information.

The network link 620 typically provides data communication through one or more networks to other data devices. For example, the network link 620 may provide a connection through the local network 622 to a host computer 624 or to data equipment operated by an Internet Service Provider (ISP). The ISP in turn provides data communication services through the Internet 628. The local network 622 and the Internet 628 both use electrical, electromagnetic or optical signals that carry digital data streams. The signals through the various networks and the signals on the network link 620 and through the communication interface 618, which carry the digital data to and from the server 630, are exemplary forms or carrier waves transporting the information.

The server 630 can send/receive messages and data, including e-mail, program code, through the network, the network link 620 and the communication interface 618. Further, the communication interface 618 can comprise a USB/Tuner and the network link 620 may be an antenna or cable for connecting the server 630 to a cable provider, satellite provider or other terrestrial transmission system for receiving messages, data and program code from another source.

The example versions of the embodiments described herein may be implemented as logical operations in a distributed processing system such as the system 600 including the servers 630. The logical operations of the embodiments may be implemented as a sequence of steps executing in the server 630, and as interconnected machine modules within the system 600. The implementation is a matter of choice and can depend on performance of the system 600 implementing the embodiments. As such, the logical operations constituting said example versions of the embodiments are referred to for e.g., as operations, steps or modules.

Similar to a server 630 described above, a client device 601 can include a processor, memory, storage device, display, input device and communication interface (e.g., e-mail interface) for connecting the client device to the Internet 628, the ISP, or LAN 622, for communication with the servers 630.

The system 600 can further include computers (e.g., personal computers, computing nodes) 605 operating in the same manner as client devices 601, where a user can utilize one or more computers 605 to manage data in the server 630.

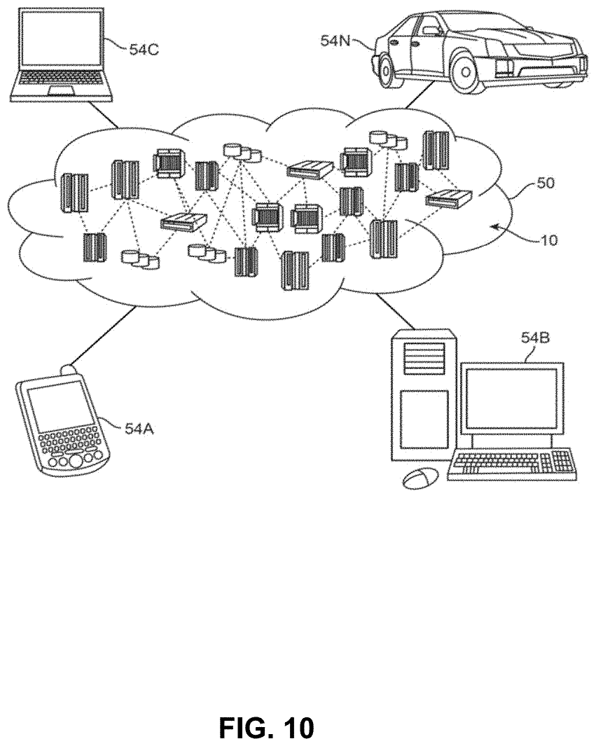

Referring now to FIG. 10, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 10 are intended to be illustrative only and that computing nodes 10 and cloud computing environment 50 can communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A computer implemented method comprising executing on a processor with addressable memory the steps of:
receiving, by a database controller that configures the processor, a user data from at least one remote server;
normalizing, by a normalizer, the user data into a uniform standard format;
generating, by the database controller, a comparison of: two or more permanent life insurance policies based on the normalized user data and one or more non-insurance investments based on the normalized user data;
receiving, by an application controller that configures the processor, an application for one or more of the generated two or more permanent life insurance policies;
determining, by the application controller, a status of the application based on an automated underwriting, wherein the automated underwriting is based on at least one of: the normalized user data, a submitted user medical information, a submitted user financial information, and a submitted user survey questionnaire; and
transmitting, by the application controller, the determined status of the application to a user device for a user.

2. The computer implemented method of claim 1, wherein the received user data comprises two or more separate user records having two or more file formats.

3. The computer implemented method of claim 2, wherein normalizing the user data further comprises:
parsing each user record to benchmark one or more user profile metrics common across the two or more file formats.

4. The computer implemented method of claim 3, wherein the one or more user profile metrics comprise at least one of: age, gender, smoker status, and a premium amount.

5. The computer implemented method of claim 3, wherein the uniform standard format is an identical format for each parsed user record.

6. The computer implemented method of claim 1, wherein generating the comparison further comprises:
receiving a user preference for one or more user profile metrics; and
sorting the normalized user data based on the received user preference.

7. The computer implemented method of claim 6, wherein generating the comparison further comprises:
selecting the two or more permanent life insurance policies for comparison based on a closest match of the sorted user data to the received user preference for the one or more user profile metrics.

8. The computer implemented method of claim 1, wherein generating the comparison further comprises:
generating one or more projections for the two or more permanent life insurance policies.

9. The computer implemented method of claim 8, wherein generating the comparison further comprises:
comparing the generated one or more projections to one or more non-insurance investments.

10. The computer implemented method of claim 9, wherein the one or more non-insurance investments includes one or more of: a savings account, S&P 500 Index, and bonds.

11. The computer implemented method of claim 1, wherein receiving the application further comprises:
populating one or more answers of the application into two or more forms associated with two or more life insurance carriers associated with the two or more permanent life insurance policies; and
submitting each form of the two or more forms to each life insurance carrier of the two or more life insurance carriers, wherein the submitted form does not require medical paperwork.

12. A system for side-by-side comparison of permanent life insurance policies comprising:
at least one remote server storing data from at least two permanent life insurance carriers; and
a user computing device comprising:
a processor having addressable memory; and
a user interface;
wherein the at least one remote server is configured to:
receive, by a database controller, user data and load the user data into a database program;
normalize, with a normalizer, the received user data into a uniform standard format;
perform, by a side-by-side comparator, advanced analytics on the normalized data to provide a side-by-side comparison of at least two permanent life insurance policies of the at least two permanent life insurance carriers based on a user profile;
apply, with an application controller, to at least one permanent life insurance policy of the two or more permanent life insurance policies of the provided side-by-side comparison; and
execute an automated underwriting to provide an approval or disapproval status to the user;
wherein the user computing device is configured to:
send, with the user interface, the user profile to the at least one remote server;
display, with the user interface, the side-by-side comparison of the at least two permanent life insurance policies and at least one non-insurance investment; and
send, with the user interface, an application for at least one of the at least two permanent life insurance policies.

13. The system of claim 12, wherein the user data received by the remote server comprises two or more separate user records having two or more file formats.

14. The system of claim 13, wherein as part of normalizing the received user data into the uniform standard format the at least one remote server is further configured to:
parse each user record to benchmark one or more user profile metrics common across the two or more file formats.

15. The system of claim 14, wherein the one or more user profile metrics comprise at least one of: age, gender, smoker status, and annual premium amount, and wherein the uniform standard format is an identical format for each parsed user record.

16. The system of claim 12, wherein as part of performing advanced analytics on the normalized data the at least one remote server is further configured to:
receive a user preference for one or more user profile metrics;
sort the normalized user data based on the received user preference; and
select the two or more permanent life insurance policies for comparison based on a closest match of the sorted user data to the received user preference for the one or more user profile metrics.

17. The system of claim 12, wherein as part of performing advanced analytics on the normalized data the at least one remote server is further configured to:
generate one or more projections for the two or more permanent life insurance policies.

18. The system of claim 17, wherein as part of performing advanced analytics on the normalized data the at least one remote server is further configured to:
compare the generated one or more projections to one or more non-insurance investments.

19. The system of claim 18, wherein the one or more non-insurance investments includes one or more of: a savings account, S&P 500 Index, and bonds.

20. The system of claim 12, wherein as part of applying to the least one permanent life insurance policy the at least one remote server is further configured to:
populate one or more answers of the application into two or more forms associated with two or more life insurance carriers associated with the two or more permanent life insurance policies; and
submit each form of the two or more forms to each life insurance carrier of the two or more life insurance carriers, wherein the submitted form does not require medical paperwork.
